(19) United States
(12) Patent Application Publication
(10) Pub. No.: US 2026/0287092 A1
(43) Pub. Date: Sep. 24, 2026

(54) HIGHLY EFFICIENT AND ECONOMICAL FLUID FLAT TUBE STRUCTURE

(71) Applicant: Xiao Zeng, Zhuhai City (CN)

(72) Inventors: Xiao Zeng, Zhuhai City (CN); Yun Zeng, Zhuhai City (CN); JianFen Zhang, Zhuhai City (CN)

(21) Appl. No.: 19/175,333

(22) Filed: Apr. 10, 2025

(30) Foreign Application Priority Data
Mar. 21, 2025 (CN) 202520502846.9

(51) Int. Cl. F16L 9/00; F28F 1/04; F28F 1/40

(52) U.S. Cl. CPC F16L 9/003; F28F 1/04; F28F 1/40

(57) ABSTRACT

A highly efficient and economical fluid flat tube structure includes a flat tube and clearance features, the flat tube is in the shape of a copper tube after clamping flat, the clearance features are set on the flat tube and distributed in upper and lower parts of the flat tube, the flat tube and clearance features are integrally molded.

### TECHNICAL FIELD

The invention belongs to the technical field of heat dissipation modules, specifically relates to a highly efficient and economical fluid flat tube structure.

### BACKGROUND ART

In the current development of server hardware, high-computing power and high-power devices continue to emerge. This makes the heat dissipation module face extremely harsh challenges, especially in the case of limited installation space, the internal space of the server is narrow, but requires the realization of high-performance heat dissipation hardware configurations, especially the heat dissipation of the memory chip under high power conditions needs to be solved.

However, when the existing heat dissipation hardware configuration is in the face of high-pressure, high-temperature operating conditions of the unit, the traditional heat pipe is prone to have deformation, expansion, extrusion and other physical characteristics changes, which constitutes a destructive threat to the chip safety.

### SUMMARY OF THE INVENTION

In view of the above, in order to overcome the defects of the prior art, the invention provides a highly efficient and economical fluid flat tube structure, effectively solving the problem that the traditional heat dissipation tube is prone to deformation, expansion, extrusion and other changes that cause damage to the chip.

In order to realize the above function, the invention adopts the following technical solution: a highly efficient and economical fluid flat tube structure includes a flat tube and clearance features, said flat tube is in the shape of a copper tube after clamping flat, said clearance features are set on the flat tube and distributed in upper and lower parts of the flat tube, said flat tube and clearance features are integrally molded.

Preferably, said clearance features are formed by processing the copper tube into a flat tube feature and then performing secondary contour extrusion compression at predetermined clearance locations based on clearance requirements.

Preferably, adapter blocks are welded to inlet and outlet ends of said flat tube.

Preferably, said flat tube is provided with welding points welded to the adapter blocks.

Preferably, said flat tube has tiny bumps on an inner wall.

The invention adopts the above structure to achieve the following beneficial effects:
1. the invention utilizes copper tube clamp flat combined with the characteristic molding process and brazing connection at the combination, without increasing the thickness of the material under the premise of a significant increase in the overall structural strength, as compared to the traditional hollow structure flat tube, which effectively solved the expansion, deformation, extrusion, and other common problems tubes; through the flat tube monobloc machining, the invention reduces the number of workpiece used, reduces the overall parts processing cost by 30%, which is not only conducive to the production efficiency increase in the mass production stage, but also significantly improve the qualified rate.
2. after processing the copper tube into a flat tube feature, secondary contour extrusion compression can be performed at specific locations to integrally form a one-piece flat tube module with clearance feature according to actual clearance needs; the fluid is circulated through the copper tube, to realize the overall cooling; profiling features can be based on different application scenarios to flexibly optimize the design; in addition, clearance features can be selectively cut at specified locations based on clearance requirements, followed by full-perimeter brazing at the cut sections. This approach simultaneously resolves leakage risks and enhances localized structural integrity; and, the monolithic flat tubes can be freely combined, and its length, width, thickness dimensions can be designed according to the needs of the actual use of the application, to meet the requirements of diversified design and use.
3.the invention effectively solve the assembly in the server memory bank heat dissipation module and reasonable assembly under the condition of narrow space, completely avoid the risk of manifold header interference, simplify the machining process technology, improve the welding quality level of the whole group of products, and at the same time ensure the heat dissipation ability of the module.

### BRIEF DESCRIPTION OF ACCOMPANY DRAWINGS

FIG. 1 is a first overall structural diagram of a highly efficient and economical fluid flat tube structure provided by the invention;

FIG. 2 is a second overall structural diagram of a highly efficient and economical fluid flat tube structure provided by the invention;

FIG. 3 is a third overall structural diagram of a highly efficient and economical fluid flat tube structure provided by the invention;

FIG. 4 is a fourth overall structural diagram of a highly efficient and economical fluid flat tube structure provided by the invention;

FIG. 5 is a structural diagram of the flat tube of a highly efficient and economical fluid flat tube structure provided by the invention.

As shown in the accompanying drawings:

1 flat tube, 2 clearance feature, 2 adapter block, 4 welding point.5 bump .

### SPECIFIC EMBODIMENT OF THE INVENTION

The accompanying drawings are used to provide a further understanding of the invention and form part of the specification and are used in conjunction with the embodiments of the invention for the purpose of explaining the invention and do not constitute a limitation of the invention.

In the description of the embodiments of the invention, it should be noted that, if the terms “center”, “up”, “down”, “left”, “right”, “vertical”, “horizontal”, “inner”, “outer”, etc. indicate orientations or positional relationships based on the orientations or positional relationships shown in the drawings or the orientations or positional relationships that the products of the invention are usually placed in when used, the orientations or positional relationships are only used for convenience of describing the invention and simplifying the description, but the terms do not indicate or imply that the devices or elements indicated must have specific orientations, be constructed in specific orientations, and operate, and therefore, should not be construed as limiting the invention. Furthermore, the terms “first”, “second”, “third” and the like are used solely to distinguish one from another and are not to be construed as indicating or implying relative importance.

The invention is further described in detail hereinafter with reference to the drawings.

As shown from FIG. 1 to FIG. 5, a highly efficient and economical fluid flat tube structure includes a flat tube 1 and clearance features 2, said flat tube 1 is in the shape of a copper tube after clamping flat, said clearance features 2 are set on the flat tube 1 and distributed in upper and lower parts of the flat tube 1, said flat tube 1 and clearance features 2 are integrally molded; the overall strength is increased without increasing the thickness of the material, and the occurrence of problems such as expansion, deformation, and extrusion is solved compared to the existing structure of the hollow structure flat tubes.

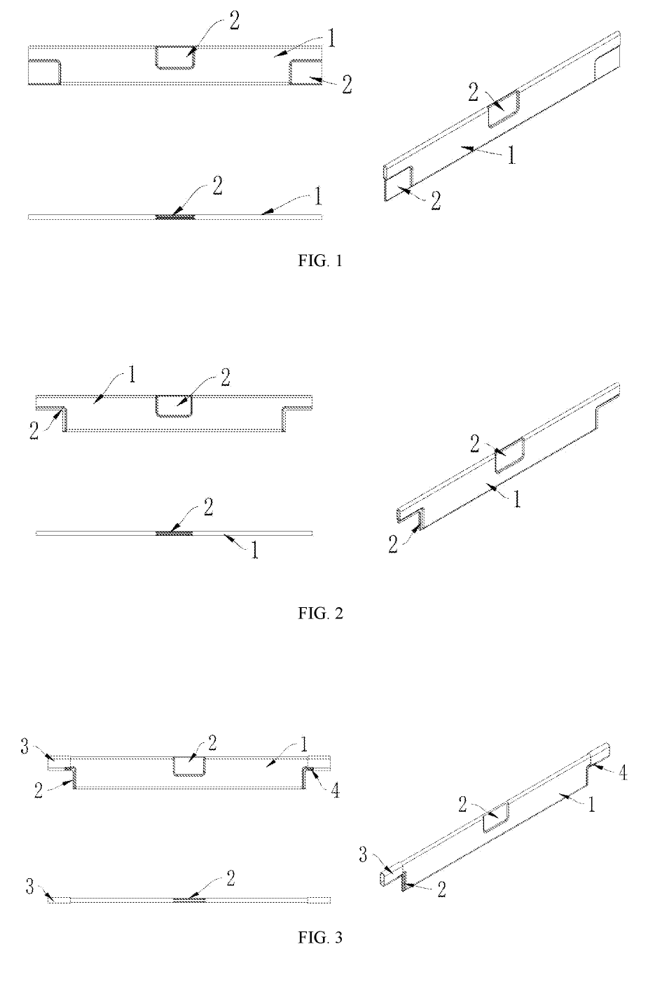

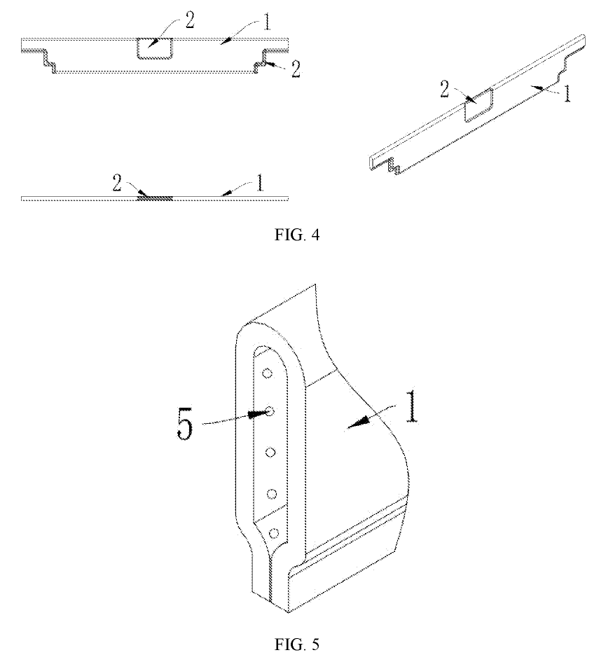

As shown in FIG. 1, FIG. 2, and FIG. 4, said clearance features 2 are formed by processing the copper tube into a flat tube feature 1 and then performing secondary contour extrusion compression at predetermined clearance locations based on clearance requirements; a one-piece flat tube 1 module with clearance feature formed makes the fluid circulated through the flat tube 1, to realize the overall cooling; shapes of the clearance features 2 can be based on different application scenarios to flexibly optimize the design.

As shown in FIG. 3, adapter blocks 3 are welded to inlet and outlet ends of said flat tube 1. According to the needs of the assembly, the flat tube 1 and the shunt can be connected by conventional brazing through connection with the adapter block 3, which greatly improves the operability of the welding process, and also realizes the best economy of the overall welding, which can greatly reduce the processing cost and improve the productivity of the parts processing, and said flat tube 1 is provided with welding points 4 welded to the adapter block 3, which is accurately positioned to facilitate welding.

As shown in FIG. 5, said flat tube 5 has tiny bumps 5 on an inner wall; the bumps 5 can also be replaced by grooves or spoilers or the like, which disturbs fluid boundary layer, enhances fluid mixing, improves the convective heat transfer coefficient, and allows the heat to be transferred from the tube wall to fluid more efficiently, and strengthens the heat dissipation capability.

When in specific use, the copper tube is first processed into a flat tube 1 feature and then performing secondary contour extrusion compression at predetermined clearance locations based on clearance requirements to form a one-piece flat tube 1 module with clearance feature, so that it is shaped to fit the server's internal mounting space and heat dissipation layout, and then firmly soldered to the shunt through brazing connection; the fluid circulates through the copper tube to realize the overall cooling;

Based on the above, clearance features 2 can be selectively cut at specified locations based on clearance requirements, followed by full-perimeter brazing at the cut sections. This approach simultaneously resolves leakage risks and enhances localized structural integrity; and, the monolithic flat tubes can be freely combined, and its length, width, thickness dimensions can be designed according to the needs of the actual use of the application, to meet the requirements of diversified design and use. Integral molding structure can reduce the use of adapter connection parts for shunt and reduces the overall processing costs;

According to the needs of the assembly, the flat tube 1 and the shunt can be connected by conventional brazing through connection with the adapter block 3, which greatly improves the operability of the welding process, and also realizes the best economy of the overall welding, which can greatly reduce the processing cost and improve the productivity of the parts processing;

the free combination of monolithic flat tubes 1 according to different application scenarios can achieve structural customization under different application scenarios, to meet the diversified demand of design and use, the monolithic flat tubes 1 supports versatile configurations with customizable dimensions in length, width, and thickness, offering exceptional design flexibility and significant cost advantages.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. A highly efficient and economical fluid flat tube structure, including a flat tube and clearance features, said flat tube is in the shape of a copper tube after clamping flat, said clearance features are set on the flat tube and distributed in upper and lower parts of the flat tube, said flat tube and clearance features are integrally molded.

2. The highly efficient and economical fluid flat tube structure of claim 1, wherein said clearance features are formed by processing the copper tube into a flat tube feature and then performing secondary contour extrusion compression at predetermined clearance locations based on clearance requirements.

3. The highly efficient and economical fluid flat tube structure of claim 2, wherein adapter blocks are welded to inlet and outlet ends of said flat tube.

4. The highly efficient and economical fluid flat tube structure of claim 3, wherein said flat tube is provided with welding points welded to the adapter blocks.

5. The highly efficient and economical fluid flat tube structure of claim 1, wherein said flat tube has tiny bumps on an inner wall.
